(19) United States
(12) Patent Application Publication
(10) Pub. No.: US 2011/0099565 A1
(43) Pub. Date: Apr. 28, 2011

(54) Disk Apparatus and Chucking Method Thereof

(76) Inventors: Shinichi Wada, Tokyo (JP); Koujiro Matsushita, Tokyo (JP)

(21) Appl. No.: 11/660,455

(22) PCT Filed: Aug. 22, 2005
(86) PCT No.: PCT/JP05/15194

§ 371 Date: Feb. 24, 2009

(30) Foreign Application Priority Data
Aug. 25, 2004 (JP) 2004-245146

(51) Int. Cl. G11B 17/04

(52) U.S. Cl. 720/604; G9B/17.013

(57) ABSTRACT

It is an object of the present invention to provide a disk apparatus and a chucking method thereof capable of reducing the disk apparatus in thickness and size.

A chucking method of a disk apparatus in which a traverse mechanism 30 comprises a spindle chassis 30A and a traverse base 30B, the spindle chassis 30A holds a plurality of columns 38 which support a spindle motor 31A and the traverse base 30B, the traverse base 30B is fitted to the columns 38 of the spindle chassis 30A, the traverse base 30B is disposed and fixed to the spindle chassis 30A in a state where the traverse base 30B is biased by a spring mounted on the columns 38 of the spindle chassis 30A so that the traverse base 30B can approach and separate from the spindle chassis 30A such that a center of the spindle motor 31A of the spindle chassis 30A and a center line of a pickup 32 lens when the pickup 32 of the traverse base 30B moves match with each other, the other end of the traverse mechanism 30 is supported on the base body 10 by the fixing cams 34A, 34B, the traverse mechanism 30 is moved in the inserting/discharging direction of the disk by the slider cam mechanism 51, thereby moving the other end of the traverse mechanism 30 away from the base body 10 by the fixing cams 34A, 34B.

### TECHNICAL FIELD

The present invention relates to a disk apparatus for recording or replaying into or from a disk-like recording medium such as a CD and a DVD, and more particularly, to a so-called slot-in type disk apparatus capable of directly inserting or discharging a disk from or to outside.

### BACKGROUND TECHNIQUE

A loading method is widely employed in conventional disk apparatuses. In this method, a disk is placed on a tray or a turntable, and the tray or the turntable is loaded into an apparatus body.

According to such a loading method, however, since the tray or the turntable is required, there is a limit for thinning the disk apparatus body.

As a slot-in type disk apparatus, there is proposed a method in which a conveying roller is abutted against a disk surface to pull the disk in (e.g., a patent document 1).

[Patent Document 1]

Japanese Patent Application Laid-open No. H7-220353

### DISCLOSURE OF THE INVENTION

### Problem to be Solved by the Invention

According to the slot-in type as proposed in the patent document 1, however, since a conveying roller which is longer than a diameter of the disk is used, the width of the apparatus must be increased, and the thickness of the apparatus is also increased due to this conveying roller.

Therefore, in the slot-in type disk apparatus, it is difficult to reduce a main body of the disk apparatus in thickness and size.

Thereupon, it is an object of the present invention to provide a disk apparatus and a chucking method thereof capable of reducing the disk apparatus in thickness and size.

Especially, when the disk apparatus is to be reduced in thickness and size, it is an object of the invention to provide a disk apparatus and a chucking method of the disk apparatus capable of securing a clearance which can not easily be secured sufficiently between a lower surface of the disk when the disk is to be inserted and traverse mechanism, especially, a clearance between a lower surface of the disk and a hub of a spindle motor when the disk is to be inserted, in the case which the traverse mechanism is diagonally lowered.

Further, it is another object of the invention to provide disk apparatus and a chucking method thereof in which one end and the other end of the traverse mechanism can move perpendicularly to a base body, and deviation between a disk center and a hub center of the spindle motor is small and the disk can be chucked stable as compared with a case in which both the one end and the other end of the traverse mechanism are separated from the base body horizontally at the same time to chuck the disk.

Further, it is another object of the invention to provide a disk apparatus and a chucking method thereof in which a disk is separated from a position limiting member without moving the position limiting member of a disk after the disk is chucked and with this, a link mechanism for retreating the position limiting member can be eliminated.

### Means for Solving Problem

A first aspect of the present invention provides a chucking method of a disk apparatus comprising a chassis outer sheath having a base body and a lid, in which a front surface of the chassis outer sheath is formed with a disk inserting opening into which a disk is directly inserted, a traverse mechanism provided on the base body comprises a spindle chassis and a traverse base, the spindle chassis holds a plurality of columns which support a spindle motor and the traverse base, the traverse base holds a pickup and drive means which moves the pickup, the traverse base is fitted to the columns of the spindle chassis, the traverse base is disposed and fixed to the spindle chassis in a state where the traverse base is biased by a spring mounted on the columns of the spindle chassis so that the traverse base can approach and separate from the spindle chassis such that a center of the spindle motor of the spindle chassis and a center line of a pickup lens when the pickup of the traverse base moves match with each other, a slider mechanism is disposed on one end side of the traverse mechanism, the slider mechanism includes a cam mechanism which brings one end side of the traverse mechanism close to and away from the base body, and a slider cam mechanism which moves the traverse mechanism in an inserting/discharging direction of the disk, a fixing cam is disposed on the other end side of the traverse mechanism, the other end of the traverse mechanism is supported on the base body by the fixing cam, the traverse mechanism is moved by the slider cam mechanism, thereby bringing the other end side of the traverse mechanism close to and away from the base body by the fixing cam, when the traverse mechanism moves toward the base body, the spindle chassis and the traverse base are biased by the springs mounted on the columns of the spindle chassis, thereby moving integrally the spindle chassis and the traverse base toward the base body until the traverse base abuts against the base body, and only the spindle chassis moves toward the base body if the traverse base abuts against the base body, and when the traverse mechanism moves away from the base body, only the spindle chassis moves away from the base body while the traverse base is in abutment against the base body, and when the traverse mechanism further moves away from the base body, the spindle chassis and the traverse base move integrally away from the base body, wherein the chucking method comprises a first step for moving the traverse mechanism toward the fixing cam, thereby moving only the other end side of the spindle chassis away from the base body, a second step for moving only the spindle chassis away from the base body until the traverse base moves away from the base body after the first step, and for moving integrally the spindle chassis and the traverse base away from the base body when the traverse base further moves away from the base body, thereby fitting the disk to a hub of the spindle motor, and a third step for moving the one end side of the traverse mechanism toward the base body after the second step.

According to a second aspect of the invention, in the chucking method of the first aspect, the traverse mechanism is moved toward the fixing cam after the second step, thereby moving the disk away from a position limiting member.

A third aspect of the invention provides a chucking method of a disk apparatus in which a traverse mechanism comprises traverse mechanism comprises a spindle chassis and a traverse base, the spindle chassis holds a plurality of columns which support a spindle motor and the traverse base, the traverse base holds a pickup and drive means which moves the pickup, the traverse base is fitted to the columns of the spindle chassis, the traverse base is disposed and fixed to the spindle chassis in a state where the traverse base is biased by a spring mounted on the columns of the spindle chassis so that the traverse base can approach and separate from the spindle chassis such that a center of the spindle motor of the spindle chassis and a center line of a pickup lens when the pickup of the traverse base moves match with each other, the one end side or the other end side of the traverse mechanism is moved perpendicularly to the base body, and the traverse mechanism is moved horizontally with respect to the base body, when the traverse mechanism moves toward the base body, the spindle chassis and the traverse base are biased by the springs mounted on the columns of the spindle chassis, thereby moving integrally the spindle chassis and the traverse base toward the base body until the traverse base abuts against the base body, only the spindle chassis moves toward the base body, if the traverse base abuts against the base body, and when the traverse mechanism moves away from the base body, only the spindle chassis moves away from the base body while the traverse base is in abutment against the base body, and when the traverse mechanism further moves away from the base body, the spindle chassis and the traverse base move integrally away from the base body, wherein the chucking method comprises a first step for moving the traverse mechanism in the horizontal direction, thereby moving only the other end side of the spindle chassis away from the base body, a second step for moving only the spindle chassis away from the base body until the traverse base moves away from the base body after the first step, and for moving integrally the spindle chassis and the traverse base away from the base body when the traverse base further moves away from the base body, thereby fitting the disk to a hub of the spindle motor, and a third step for moving the one end side of the traverse mechanism toward the base body after the second step.

According to a fourth aspect of the invention, in the chucking method of the third aspect, the traverse mechanism is moved in the horizontal direction after the second step, thereby moving the disk away from a position limiting member.

A fifth aspect of the invention provides a disk apparatus comprising a chassis outer sheath having a base body and a lid, in which a front surface of the chassis outer sheath is formed with a disk inserting opening into which a disk is directly inserted, a traverse mechanism provided on the base body comprises a spindle chassis and a traverse base, the spindle chassis holds a plurality of columns which support a spindle motor and the traverse base, the traverse base holds a pickup and drive means which moves the pickup, the traverse base is fitted to the columns of the spindle chassis, the traverse base is disposed and fixed to the spindle chassis in a state where the traverse base is biased by a spring mounted on the columns of the spindle chassis so that the traverse base can approach and separate from the spindle chassis such that a center of the spindle motor of the spindle chassis and a center line of a pickup lens when the pickup of the traverse base moves match with each other, wherein a slider mechanism is disposed on one end side of the traverse mechanism, the slider mechanism includes a cam mechanism which brings one end side of the traverse mechanism close to and away from the base body, and a slider cam mechanism which moves the traverse mechanism in an inserting/discharging direction of the disk, a fixing cam is disposed on the other end side of the traverse mechanism, the other end side of the traverse mechanism is supported on the base body by the fixing cam, the traverse mechanism is moved by the slider cam mechanism, thereby bringing the other end side of the traverse mechanism close to and away from the base body by the fixing cam, when the traverse mechanism moves toward the base body, the spindle chassis and the traverse base are biased by the springs mounted on the columns of the spindle chassis , thereby moving integrally the spindle chassis and the traverse base toward the base body until the traverse base abuts against the base body, and only the spindle chassis moves toward the base body if the traverse base abuts against the base body, and when the traverse mechanism moves away from the base body, only the spindle chassis moves away from the base body while the traverse base is in abutment against the base body, and when the spindle chassis further moves away from the base body, the spindle chassis and the traverse base move integrally away from the base body.

According to a sixth aspect of the invention, in the disk apparatus of the fifth aspect, the traverse mechanism is moved toward a fixing cam by the slider cam mechanism, thereby moving the disk away from a position limiting member.

### EFFECT OF THE INVENTION

According to the present invention, it is possible to reduce the disk apparatus in thickness and size.

Especially according to the invention, it is possible to sufficiently secure a clearance between a disk lower surface when the disk is inserted and the traverse mechanism, especially between the spindle motor and a hub.

According to the invention, it is possible to stably chuck a disk.

According to the invention, after a disk is chucked, the disk is separated from the position limiting member without moving the position limiting member of the disk, and it is possible to eliminate a ling mechanism which retreats the position limiting member.

### BRIEF DESCRIPTION OF THE DRAWINGS

FIG. 1 is a plan view of an essential portion of a base body of a disk apparatus according to an embodiment of the present invention;

FIG. 2 is a side sectional view of an essential portion of the disk apparatus;

FIG. 3 is a side sectional view of a sub-slider of the disk apparatus;

FIG. 4 is a plan view of an essential portion of the base body showing a state where chucking motion of a disk of the disk apparatus according to the embodiment is started;

FIG. 5 is a side view of an essential portion of the state;

FIG. 6 is a side view of the sub-slider in this state;

FIG. 7 is a plan view of an essential portion of the base body showing a state where a first predetermined time is elapsed after the state shown in FIG. 4;

FIG. 8 is a side sectional view of an essential portion in this state;

FIG. 9 is a side view of the sub-slider in this state;

FIG. 10 is a plan view of an essential portion of the base body showing a state where a second predetermined time is elapsed after the state shown in FIG. 7 and the traverse mechanism 30 is moved to the highest position;

FIG. 11 is a side sectional view of an essential portion in this state;

FIG. 12 is a side view of the sub-slider in this state;

FIG. 13 is a plan view of an essential portion of the base body showing a state where a third predetermined time is elapsed after the state shown in FIG. 10 and showing a recording/replaying state of a disk;

FIG. 14 is a side sectional view of an essential portion in this state;

FIG. 15 is a side view of the sub-slider in this state;

FIG. 16 is a plan view of a spindle chassis of the ds according to an embodiment of the present invention; and

FIG. 17 is a plan view of a traverse base of the disk apparatus of an embodiment of the present invention.

### EXPLANATION OF SYMBOLS

10 base body
11 disk inserting opening
30 traverse mechanism
30A spindle chassis
30B traverse base
31A spindle motor
32 pickup
40 main slider
50 sub-slider
51 slider cam mechanism
52 vertically moving cam mechanism
130 lid

### BEST MODE FOR CARRYING OUT THE INVENTION

According to the chucking method of the disk apparatus of the first aspect of the present invention, the method comprises a first step for moving the traverse mechanism toward the fixing cam, thereby moving only the other end side of the spindle chassis away from the base body, a second step for moving only the spindle chassis away from the base body until the traverse base moves away from the base body after the first step, and for moving integrally the spindle chassis and the traverse base away from the base body when the traverse base further moves away from the base body, thereby fitting the disk to a hub of the spindle motor, and a third step for moving the one end side of the traverse mechanism toward the base body after the second step.

According to this aspect , when one end or the other end of the traverse mechanism can move perpendicularly to the base body, deviation between the disk center and the hub center of the spindle motor is small and the disk can be chucked stable as compared with a case in which both the one end and the other end of the traverse mechanism are separated from the base body horizontally at the same time.

Further, according to this aspect, when the traverse mechanism moves toward the base body, the spindle chassis and the traverse base are biased by the springs mounted on the columns of the spindle chassis, thereby moving integrally the spindle chassis and the traverse base toward the base body until the traverse base abuts against the base body, and only the spindle chassis moves toward the base body if the traverse base abuts against the base body. With this, a sufficient clearance can be secured between the lower surface of the disk when the disk is inserted and the hub of the spindle motor. Therefore, the chassis outer sheath can be reduced in thickness.

According to the second aspect of the invention, in the chucking method of the first aspect, the traverse mechanism is moved toward the fixing cam after the second step, thereby moving the disk away from a position limiting member. According to this aspect, the disk is separated from the position limiting member without moving the position limiting member of the disk after the disk is chucked, thereby eliminating the link mechanism which retreats the position limiting member.

According to the chucking method of the disk apparatus of the third aspect of the invention, the chucking method comprises a first step for moving the traverse mechanism in the horizontal direction, thereby moving only the other end side of the spindle chassis away from the base body, a second step for moving only the spindle chassis away from the base body until the traverse base moves away from the base body after the first step, and for moving integrally the spindle chassis and the traverse base away from the base body when the traverse base further moves away from the base body, thereby fitting the disk to a hub of the spindle motor, and a third step for moving the one end side of the traverse mechanism toward the base body after the second step.

According to this aspect , when one end or the other end of the traverse mechanism can move perpendicularly to the base body, deviation between the disk center and the hub center of the spindle motor is small and the disk can be chucked stable as compared with a case in which both the one end and the other end of the traverse mechanism are separated from the base body horizontally at the same time.

Further, according to this aspect, when the traverse mechanism moves toward the base body, the spindle chassis and the traverse base are biased by the springs mounted on the columns of the spindle chassis, thereby moving integrally the spindle chassis and the traverse base toward the base body until the traverse base abuts against the base body. With this, a sufficient clearance can be secured between the lower surface of the disk when the disk is inserted and the hub of the spindle motor. Therefore, the chassis outer sheath can be reduced in thickness.

According to the fourth aspect of the invention, in the chucking method of the third aspect, the traverse mechanism is moved in the horizontal direction after the second step, thereby moving the disk away from a position limiting member. According to this aspect, the disk is separated from the position limiting member without moving the position limiting member of the disk after the disk is chucked, thereby eliminating the link mechanism which retreats the position limiting member.

According to the disk apparatus of the fifth aspect of the present invention, a slider mechanism is disposed on one end side of the traverse mechanism, the slider mechanism includes a cam mechanism which brings one end side of the traverse mechanism close to and away from the base body, and a slider cam mechanism which moves the traverse mechanism in an inserting/discharging direction of the disk, a fixing cam is disposed on the other end side of the traverse mechanism, the other end side of the traverse mechanism is supported on the base body by the fixing cam, the traverse mechanism is moved by the slider cam mechanism, thereby bringing the other end side of the traverse mechanism close to and away from the base body by the fixing cam, when the traverse mechanism moves toward the base body, the spindle chassis and the traverse base are biased by the springs mounted on the columns of the spindle chassis, thereby moving integrally the spindle chassis and the traverse base toward the base body until the traverse base abuts against the base body, and only the spindle chassis moves toward the base body if the traverse base abuts against the base body, and when the traverse mechanism moves away from the base body, only the spindle chassis moves away from the base body while the traverse base is in abutment against the base body, and when the spindle chassis further moves away from the base body, the spindle chassis and the traverse base move integrally away from the base body.

According to this aspect , when one end or the other end of the traverse mechanism can move perpendicularly to the base body, deviation between the disk center and the hub center of the spindle motor is small and the disk can be chucked stable as compared with a case in which both the one end and the other end of the traverse mechanism are separated from the base body horizontally at the same time.

Further, according to this aspect, when the traverse mechanism moves toward the base body, the spindle chassis and the traverse base are biased by the springs mounted on the columns of the spindle chassis, thereby moving integrally the spindle chassis and the traverse base toward the base body until the traverse base abuts against the base body. With this, a sufficient clearance can be secured between the lower surface of the disk when the disk is inserted and the hub of the spindle motor. Therefore, the chassis outer sheath can be reduced in thickness.

According to the sixth aspect of the invention, in the disk apparatus of the fifth aspect, the traverse mechanism is moved toward a fixing cam by the slider cam mechanism, thereby moving the disk away from the position limiting member. According to this aspect, the disk is separated from the position limiting member without moving the position limiting member of the disk after the disk is chucked, thereby eliminating the link mechanism which retreats the position limiting member.

### EMBODIMENT

A disk apparatus according to an embodiment of the present invention will be explained.

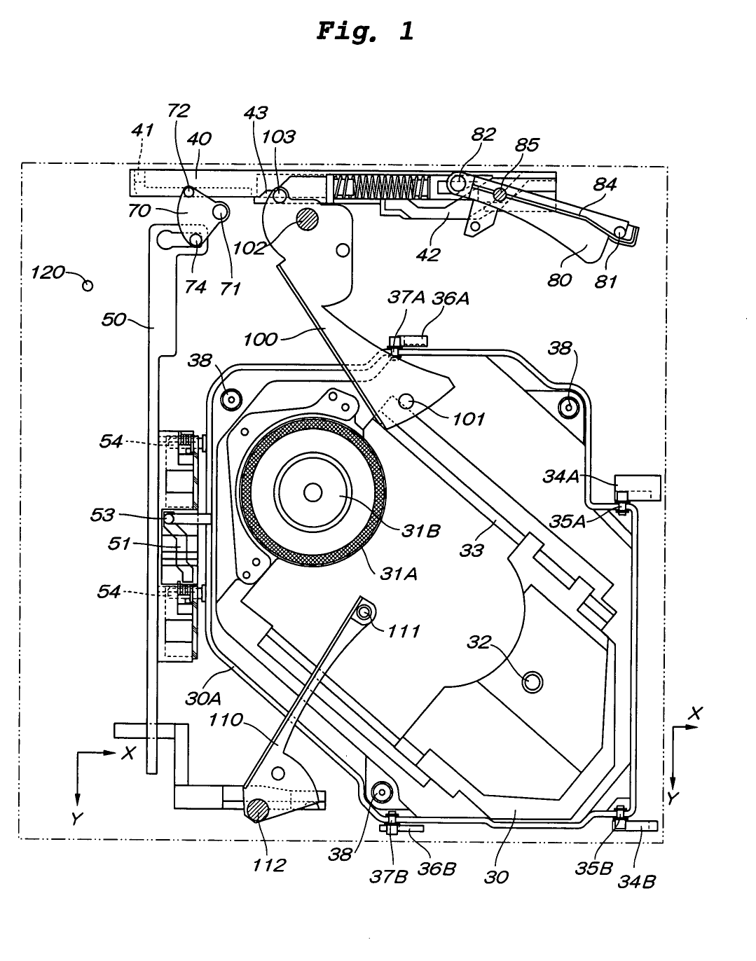

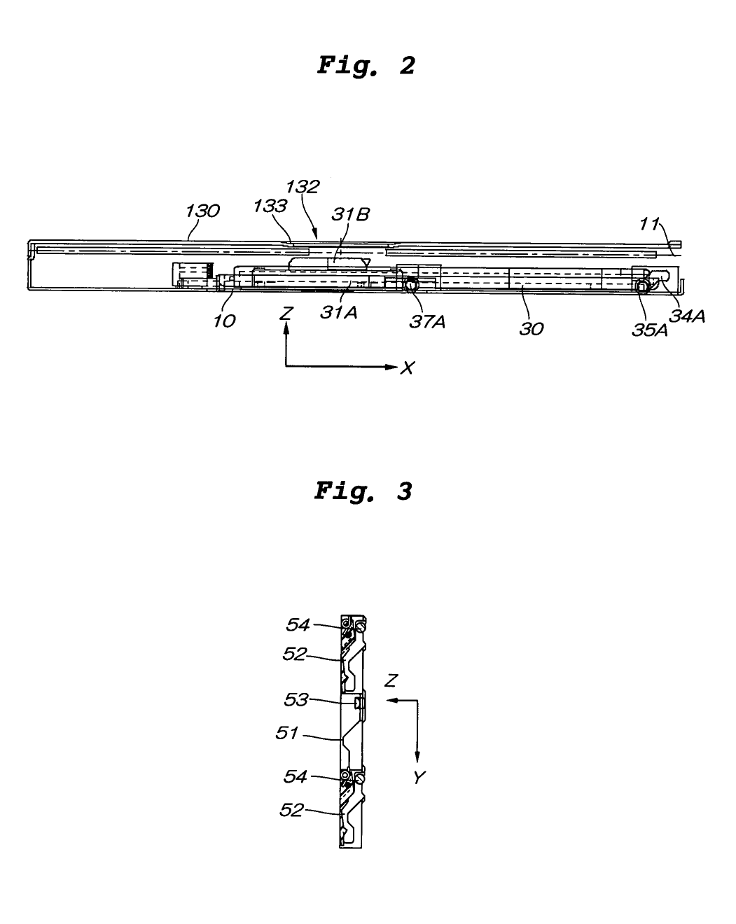

FIG. 1 is a plan view of an essential portion of a base body of a disk apparatus according to an embodiment of the invention, FIG. 2 is a side sectional view of an essential portion of the disk apparatus, and FIG. 3 is a side sectional view of a sub-slider of the disk apparatus.

The disk apparatus of this embodiment includes a chassis outer sheath comprising a base body and a lid. A bezel is mounted on a front surface of the chassis outer sheath. The disk apparatus of this embodiment is a slot-in type disk apparatus in which a disk is directly inserted from a disk inserting opening formed in the bezel.

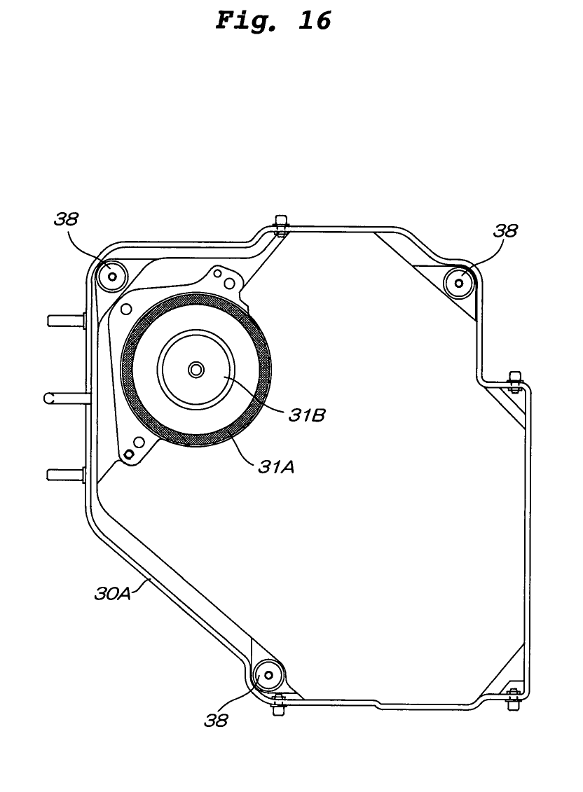

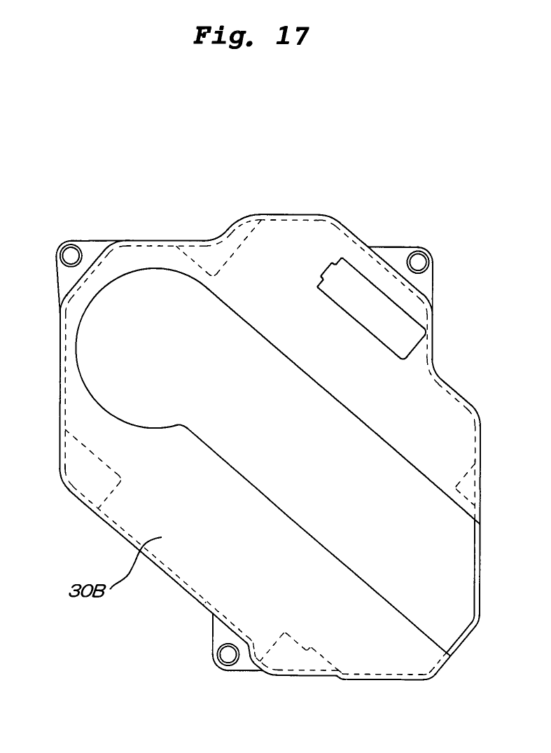

A disk inserting opening 11 into which a disk is directly inserted is formed in a front side of a base body 10. A traverse mechanism 30 is disposed in the base body 10. The traverse mechanism 30 comprises a spindle chassis 30A and a traverse base 30B as shown in FIGS. 16 and 17.

FIG. 16 is a plan view of the spindle chassis 30A of the disk apparatus according to the embodiment of the present invention, and FIG. 17 is a plan view of the traverse base 30B of the disk apparatus of the embodiment of the invention.

The spindle chassis 30A holds a spindle motor 31A and three columns 38 which support the traverse base 30B.

A rotation shaft of the spindle motor 31A includes a hub 31B which holds a disk. The spindle motor 31A is provided on one end of the spindle chassis 30A.

The traverse base 30B holds a pickup 32. The pickup 32 can move from one end to the other end of the traverse base 30B. The traverse base 30B also holds drive means 33 which moves the pickup 32.

The drive means 33 includes a drive motor, a pair of rails for allowing the pickup 32 to slide, and a gear mechanism for transmitting a driving force of the drive motor to the pickup 32. The pair of rails are disposed on the opposite sides of the pickup 32 such that the one end and the other end of the traverse base 30B are in contact with each other.

The traverse base 30B is fitted to the columns 38 of the spindle chassis 30A with respect to the spindle chassis 30A, and the traverse base 30B is biased by a spring such that the traverse base 30B can approach and separate from the spindle chassis 30A, and in this state, the traverse base 30B is disposed and fixed so that a center of the spindle motor 31A and a center line of a pickup lens when the pickup 32 moves match with each other.

A spindle motor 31A and a pickup 32 are disposed in the spindle chassis 30A. The spindle motor 31A is located at a central portion of the base body 10. A reciprocating range of the pickup 32 is located closer to the disk inserting opening 11 than the spindle motor 31A. The reciprocating direction of the pickup 32 is different from the inserting direction of the disk. Here, an angle formed between the reciprocating direction of the pickup 32 and the inserting direction of the disk is in a range of 40 to 45°.

The traverse mechanism 30 is supported on the base body 10 by a pair of fixing cams 34A and 34B. It is preferable that the pair of fixing cams 34A and 34B are disposed closer to the disk inserting opening 11 than the spindle motor 31A and are disposed at the other end position of the traverse mechanism 30. In this embodiment, the fixing cam 34A is provided at a central portion in the vicinity of an inside of the disk inserting opening 11, and the fixing cam 34B is provided on the one end in the vicinity of the inside of the disk inserting opening 11. The fixing cams 34A and 34B comprise grooves of predetermined lengths extending in the inserting direction of the disk. One end of each of the grooves closer to the one end of the disk inserting opening 11 is separated away from the base body 10 than the other end by a first Y axis distance. Cam pins 35A and 35B provided on the spindle chassis 30A slide in the grooves of the fixing cams 34A and 34B, thereby displacing the traverse mechanism 30 in the inserting/discharging direction (X axis direction) of the disk and displacing the traverse mechanism 30 in a direction (Z axis direction) in which the traverse mechanism 30 is brought close to and away from the base body 10.

A main slider 40 and a sub-slider 50 which move the traverse mechanism 30 will be explained next.

The main slider 40 and the sub-slider 50 are disposed on the side of the spindle motor 31A. One end of the main slider 40 is disposed in a direction of the front surface of the base body 10 and the other end is disposed in a direction of a rear surface of the base body 10. The sub-slider 50 is disposed in a direction intersecting with the main slider 40 at right angles.

A cam mechanism for displacing the traverse mechanism 30 comprises a slider cam mechanism 51 and a vertically moving cam mechanism 52. The cam mechanism is provided on the sub-slider 50. The slider cam mechanism 51 comprises a groove of a predetermined length extending in a moving direction of the sub-slider 50. This groove approaches the disk inserting opening 11 (X axis direction) in stages from its one end (closer to the main slider 40) toward the other end. The spindle chassis 30A is provided with a slide pin 53. The slide pin 53 slides in the groove of the slider cam mechanism 51, thereby displacing the traverse mechanism 30 in the inserting/discharging direction (X axis direction) of the disk. The vertically moving cam mechanism 52 comprises a groove of a predetermined length extending in the moving direction of the sub-slider 50. A distance (Z axis distance) of the groove is varied in stages from one end thereof (closer to the main slider 40) toward the other end. The vertically moving pin 54 provided on the spindle chassis 30A slides in the groove of the vertically moving cam mechanism 52, thereby displacing the traverse mechanism 30 in a direction (Z axis direction) in which the traverse mechanism 30 is brought close to and away from the base body 10.

A loading motor (not shown) is disposed on one end of the main slider 40. A drive shaft of the loading motor and one end of the main slider 40 are connected to each other through a gear mechanism (not shown).

The main slider 40 can slide in a longitudinal direction (X axis direction) by driving the loading motor. The main slider 40 is connected to the sub-slider 50 through a cam lever 70.

The cam lever 70 includes a turning fulcrum 71, the cam lever 70 is engaged with a cam groove 41 provided in the main slider 40 through a pin 72, and the cam lever 70 is engaged with a cam groove provided in the sub-slider 50 through a pin 74.

The cam lever 70 moves the sub-slider 50 in association with movement of the main slider 40, moves the slider cam mechanism 51 and the vertically moving cam mechanism 52 by the movement of the sub-slider 50, and displaces the traverse mechanism 30.

The traverse mechanism 30 is further supported on the base body 10 by a pair of fixing cams 36A and 36B also. It is preferable that the pair of fixing cams 36A and 36B are disposed between the fixing cams 34A and 34B and the sub-slider 50, and are disposed at intermediate positions between the fixing cams 34A and 34B and the sub-slider 50. The fixing cams 36A and 36B comprise grooves of predetermined lengths which are the same structures as those of the fixing cams 34A and 34B. Cam pins 37A and 37B provided on the spindle chassis 30A slide in the fixing cams 36A and 36B, thereby displacing the traverse mechanism 30 in the inserting direction of the disk, and displacing the traverse mechanism 30 in a direction in which the traverse mechanism 30 is brought close to and away from the base body 10.

The above-explained spindle chassis 30A and traverse base 30B are provided on the traverse mechanism 30. The above explained traverse mechanism 30, fixing cams 34A, 34B, 36A, 36B, main slider 40, sub-slider 50, and loading motor are provided on the base body 10, and form a disk-inserting space between a lid 130 and these members.

Next, a guide member for supporting a disk and a lever member for operating the disk will be explained.

A first disk guide (not shown) having a predetermined length is provided on one end side of the base body 10 closer to the disk inserting opening 11. The first disk guide has a groove having a U-shaped cross section as viewed from a disk inserting direction. A disk is supported by the groove.

A pulling-in lever 80 is provided on the other end side of the base body 10 closer to the disk inserting opening 11. A movable side end of the pulling-in lever 80 includes a second disk guide 81. The second disk guide 81 comprises a cylindrical roller, and the second disk guide 81 is turnably provided on the movable side end of the pulling-in lever 80.

The pulling-in lever 80 is disposed such that its movable side end is operated on the side of the disk inserting opening 11 than its fixed side end, and the fixed side end is provided with a turning fulcrum 82. A third disk guide 84 having a predetermined length is provided between the movable side end and the fixed side end of the pulling-in lever 80. The pulling-in lever 80 includes a pin 85. If the pin 85 slides in a cam groove 42 of the main slider 40, the pulling-in lever 80 is operated. That is, the pulling-in lever 80 is operated such that as the main slider 40 moves, the second disk guide 81 is brought close to and away from the spindle motor 31A.

The base body 10 is provided with a discharging lever 100. A guide 101 is provided on a movable side end of one end of the discharging lever 100. The guide 101 comprises a cylindrical roller. A turning fulcrum 102 is provided on the other end of the discharging lever 100. The discharging lever 100 is operated in association with motion of the main slider 40 by a pin 103 and a cam groove 43.

A discharging lever 110 is provided on the base body 10 on the side opposed to the discharging lever 110. A disk guide 111 is provided on a movable side end of one end of the discharging lever 110. It is preferable that the discharging lever 110 also comprises a cylindrical roller. A turning fulcrum 112 is provided on the other end of the discharging lever 110. Like the discharging lever 100, this discharging lever 110 limits a position of the disk when the disk is loaded or chucked, and conveys and guides of the disk when it is inserted or discharged.

The base body 10 is provided at its rear side with a fixing pin 120. The fixing pin 120 limits a position of a disk when the disk is loaded or chucked.

As shown in FIG. 2, the chassis outer sheath comprises the base body 10 and a lid 130. The lid 130 is provided at its central portion with an opening 132. The opening 132 is a circular opening having a radius greater than a center hole of the disk. Therefore, the opening 132 is larger than the hub 31B of the spindle motor 31A which is fitted into the center hole of the disk.

The opening 132 is formed at its outer periphery with a narrowed portion 133 projecting toward the base body 10.

The entire inner peripheral surface of the lid 130 is coated with fluorine-based material compounding urethane beads are mixed. Only a contact surface of the narrowed portion 133 of the lid 130 with respect to a disk may be coated with the fluorine-based material. A preferable coating material includes urethane resin compounding beads of 20μ diameter in which 5% fluorine and 1.0 to 1.5% silicon are mixed therein. It is preferable that the coefficient of friction of the coating material is 0.2 to 0.6, and more preferably 0.55 or less.

A motion mechanism of the traverse mechanism 30 will be explained using FIGS. 1 to 15.

Positions of the cam mechanism and the pin in FIGS. 1 to 3 show a standby state of a disk.

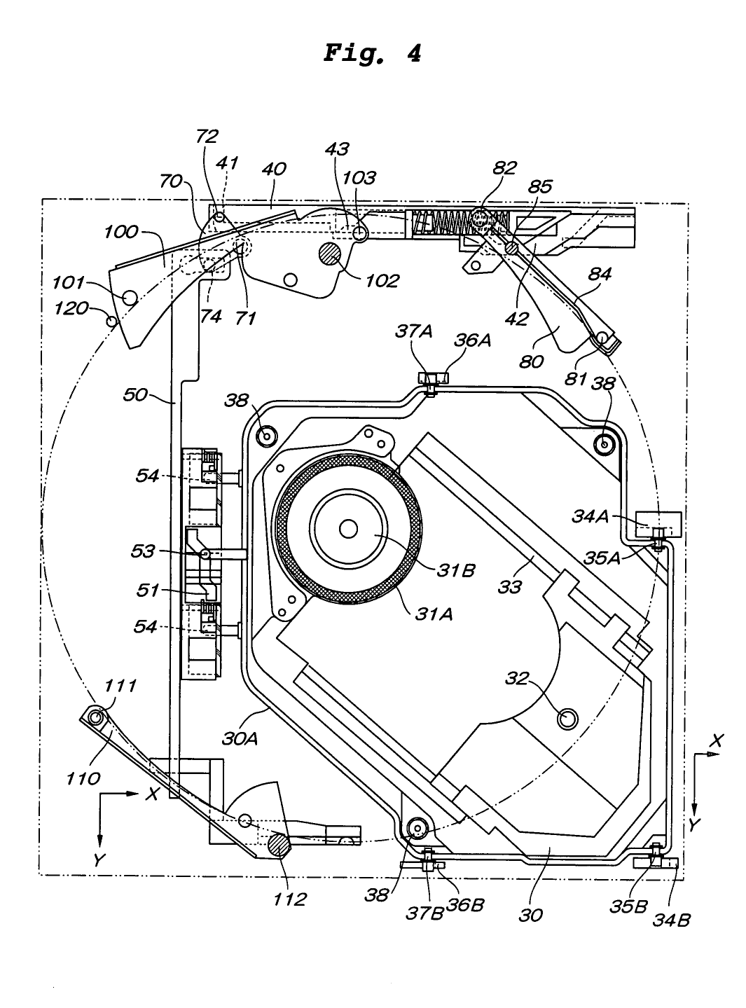

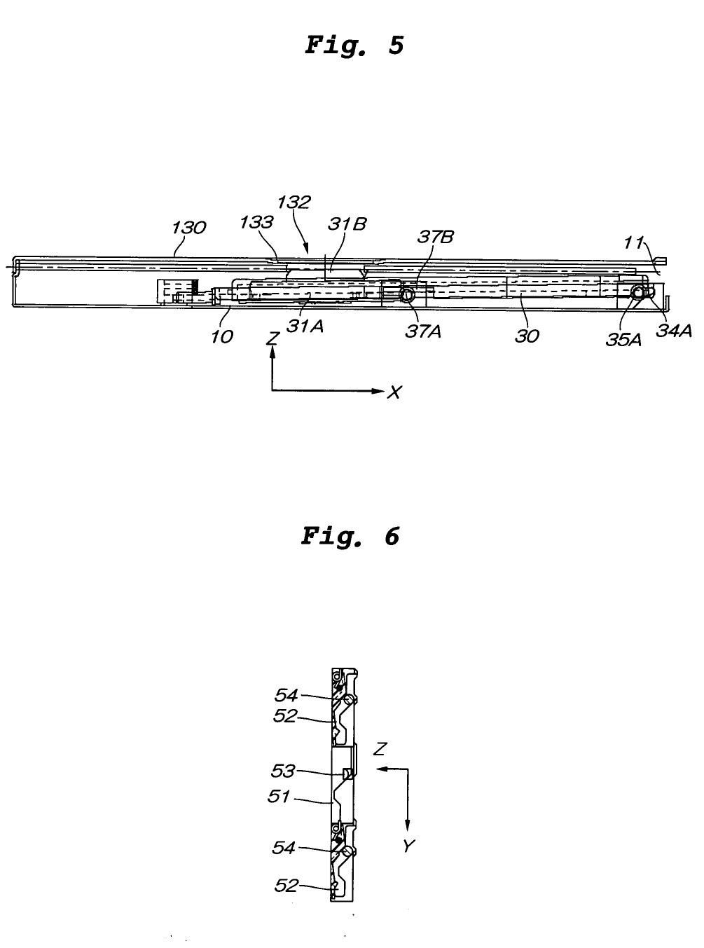

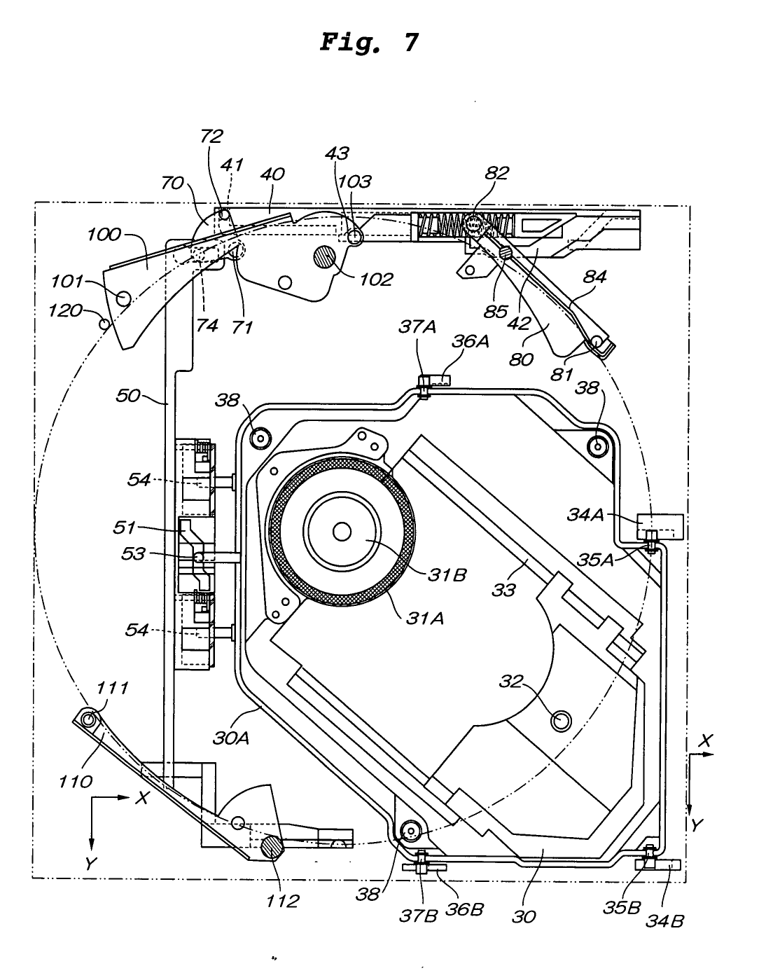

FIG. 4 is a plan view of an essential portion of the base body showing a state where chucking motion of a disk of the disk apparatus according to the embodiment is started, FIG. 5 is a side view of an essential portion in the state, and FIG. 6 is a side view of the sub-slider in this state.

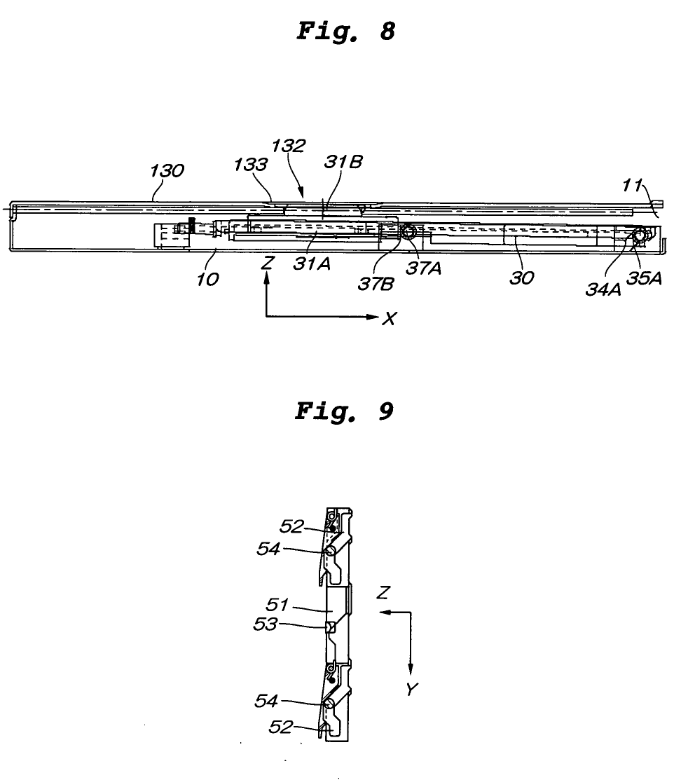

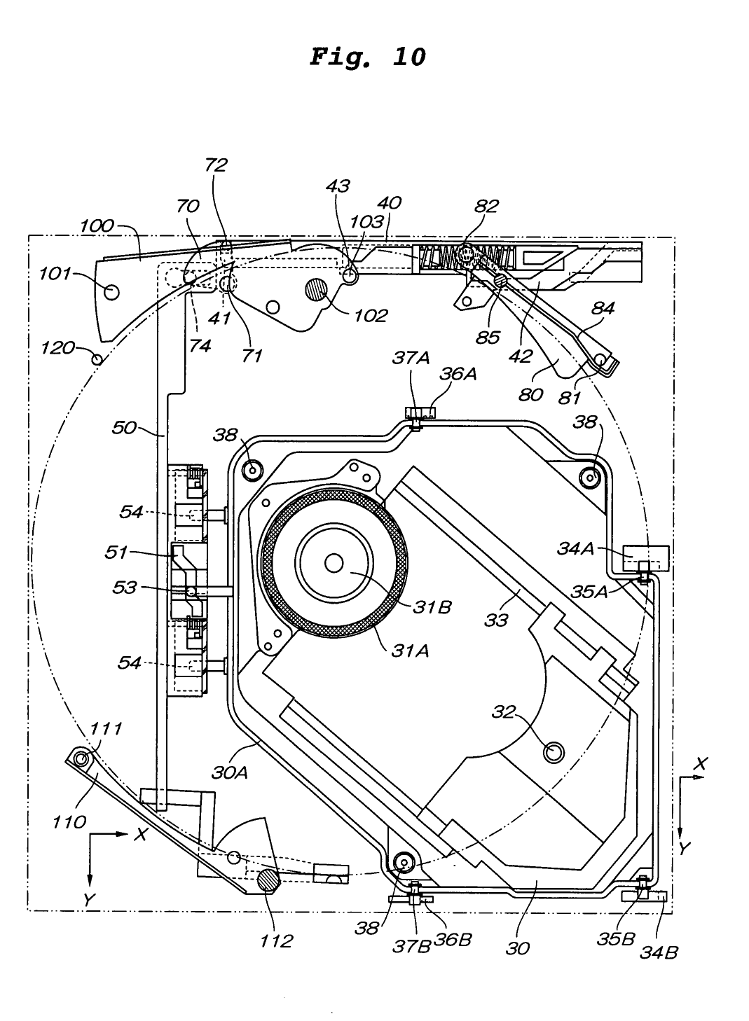

FIG. 7 is a plan view of an essential portion of the base body showing a state where a first predetermined time is elapsed after the state shown in FIG. 4, FIG. 8 is a side sectional view of an essential portion in this state, and FIG. 9 is a side view of the sub-slider in this state.

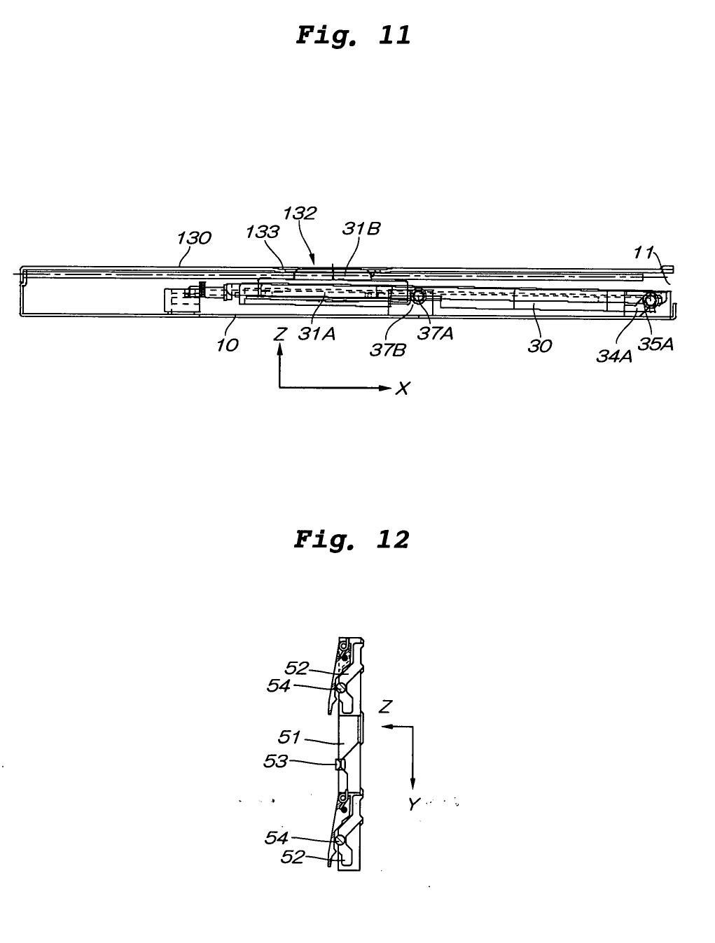

FIG. 10 is a plan view of an essential portion of the base body showing a state where a second predetermined time is elapsed after the state shown in FIG. 7 and the traverse mechanism 30 is moved to the highest position, FIG. 11 is a side sectional view of an essential portion in this state, and FIG. 12 is a side view of the sub-slider in this state.

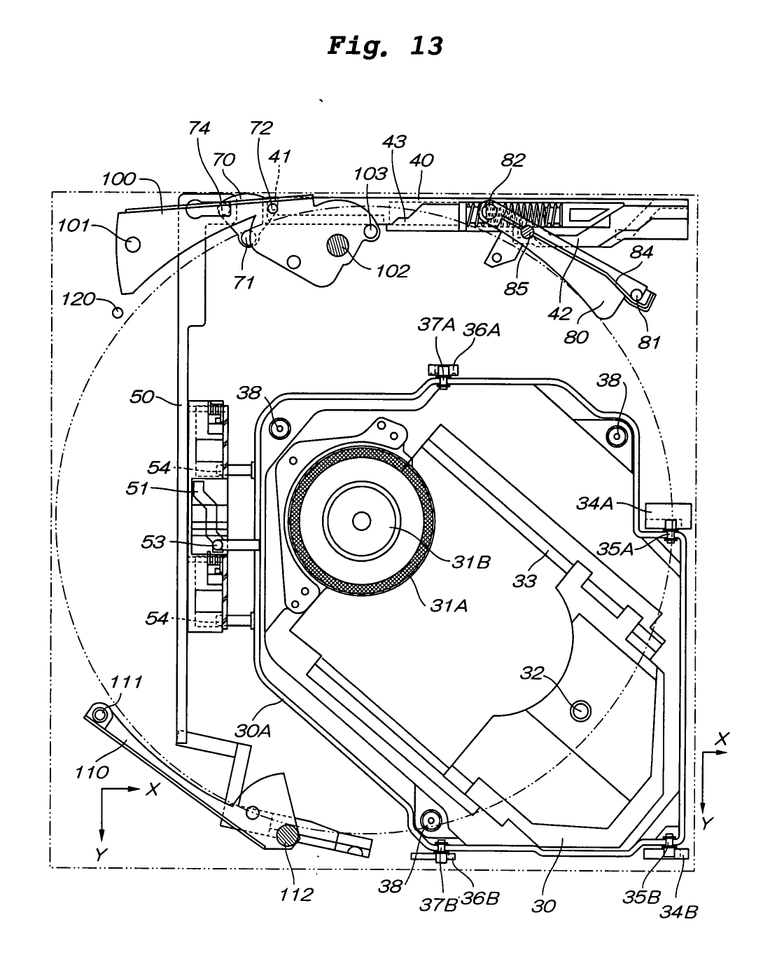

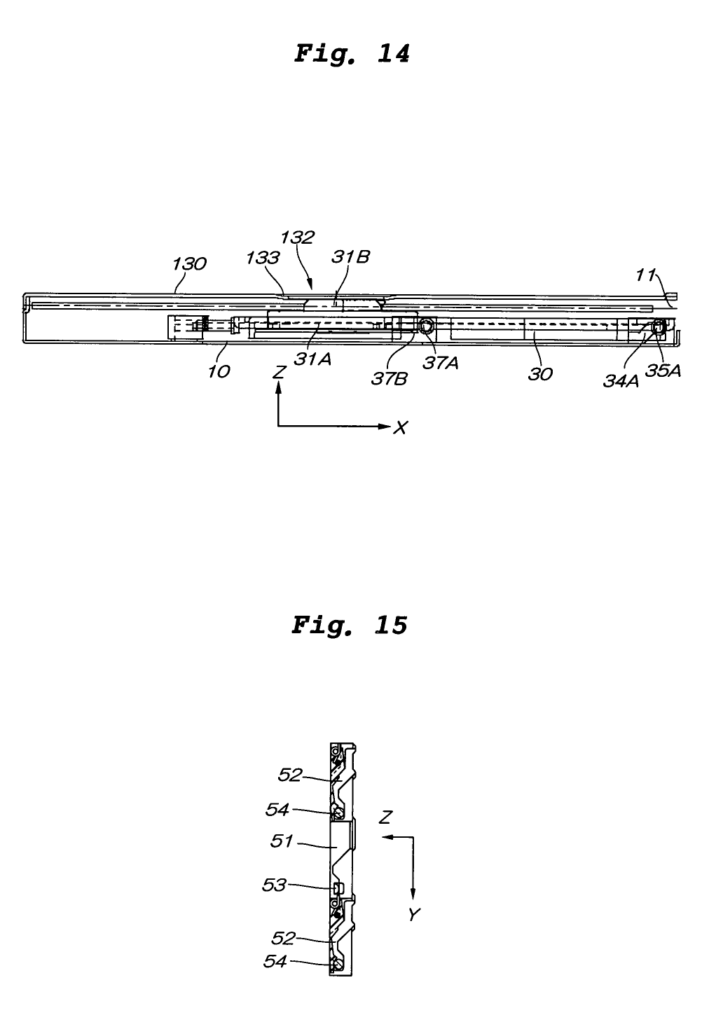

FIG. 13 is a plan view of an essential portion of the base body showing a state where a third predetermined time is elapsed after the state shown in FIG. 10 and showing a recording/replaying state of a disk, FIG. 14 is a side sectional view of an essential portion in this state, and FIG. 15 is a side view of the sub-slider in this state.

In the standby state of the disk, as shown in FIGS. 1 to 3, the traverse mechanism 30 is disposed at the rearmost position closest to the base body 10.

That is, in this state, the slide pin 53 is located on one end (close to the main slider 40) of the slider cam mechanism 51. Therefore, the traverse mechanism 30 is disposed at a position close to the rearmost side. The cam pins 35A and 35B are located on the other ends of the grooves of the fixing cams 34A and 34B. Therefore, the other end (close to the pickup 32) of the traverse mechanism 30 is disposed at a position closest to the base body 10. The vertically moving pin 54 is located at one end (close to the main slider 40) of the vertically moving cam mechanism 52. Therefore, the one end (close to the spindle motor 31A) of the traverse mechanism 30 is disposed at a position closest to the base body 10.

The main slider 40 moves toward the disk inserting opening 11 from the state shown in FIG. 1, and with the movement of the main slider 40, the sub-slider 50 moves toward the main slider 40.

In a state where the chucking motion is started, as shown in FIGS. 4 to 6, the traverse mechanism 30 moves toward the disk inserting opening 11 by the first X axis distance, and the other end of the traverse mechanism 30 is disposed at a position away from the base body 10 by the first Y axis distance.

That is, in this state, the slide pin 53 moves the slider cam mechanism 51 by the first Y axis distance, and the traverse mechanism 30 moves toward the disk inserting opening 11 by the first X axis distance. Thus, the cam pins 35A and 35B move toward one ends of the grooves of the fixing cams 34A and 34B by the first X axis distance, and the other end (close to the pickup 32) of the traverse mechanism 30 is disposed at a position away from the base body 10 by the first Z axis distance. The vertically moving pin 54 moves from one end (close to the main slider 40) of the vertically moving cam mechanism 52 by the first Y axis distance, and moves one end (closer to the spindle motor 31A) of the traverse mechanism 30 from the base body 10 by the second Z axis distance. The chucking operation of the conveyed disk by the hub 31B in this state is started.

The main slider 40 further moves toward the disk inserting opening 11 from the state shown in FIG. 4, and with this, the sub-slider 50 moves toward the main slider 40.

In a state where the chucking motion is further carried out for a first predetermined time from the state shown in FIG. 4, the other end of the traverse mechanism 30 is disposed at a location away from the base body 10 by a third Z axis distance (third Z axis distance>second Z axis distance) as shown in FIGS. 7 to 9.

That is, in this state, the slide pin 53 moves the slider cam mechanism 51 by the second Y axis distance, but since the groove of the slider cam mechanism 51 is provided in parallel in the moving direction (Y axis direction) of the sub-slider 50, in this moving range of the slider cam mechanism 51 the traverse mechanism 30 does not move toward the disk inserting opening 11. Therefore, the cam pins 35A and 35B do not also move in the grooves of the fixing cams 34A and 34B. The vertically moving pin 54 moves in the groove of the vertically moving cam mechanism 52 by the second Y axis distance, and moves the one end (close to the spindle motor 31A) of the traverse mechanism 30 from the base body 10 by the third Z axis distance. In this state, a disk of 1.2 mm thickness abuts against the narrowed portion 133 of the lid 130, and the chucking of the disk is completed.

If the main slider 40 further moves toward the disk inserting opening 11 from the state shown in FIG. 7, the sub-slider 50 further moves toward the main slider 40.

In a state where the chucking motion is carried out for the third predetermined time from the state shown in FIG. 7, the other end of the traverse mechanism 30 is disposed for the fourth Z axis direction which is most separated from the base body 10 as shown in FIGS. 10 to 12.

That is, in this state, the slide pin 53 moves the slider cam mechanism 51 by a third Y axis distance, but since the groove of the slider cam mechanism 51 is provided in parallel in the moving direction (Y axis direction) of the sub-slider 50, in this moving range of the slider cam mechanism 51 the traverse mechanism 30 does not move toward the disk inserting opening 11. Therefore, the cam pins 35A and 35B do not move in the grooves of the fixing cams 34A and 34B. The vertically moving pin 54 moves in the groove of the vertically moving cam mechanism 52 by the third Y axis distance, and moves the one end (close to the spindle motor 31A) of the traverse mechanism 30 from the base body 10 by the fourth Z axis distance (highest position) . In this state, the chucking of the disk of 1.2 mm thickness or more is completed.

If the main slider 40 further moves toward the disk inserting opening 11 from the state shown in FIG. 10, the sub-slider 50 further moves toward the main slider 40.

As shown in FIGS. 13 to 15, the traverse mechanism 30 moves toward the disk inserting opening 11, the other end of the traverse mechanism 30 moves in a direction approaching the base body 10, and is disposed at a position of the first Z axis distance.

That is, in this state, the slide pin 53 moves the slider cam mechanism 51 by a fourth Y axis direction, and the traverse mechanism 30 moves toward the disk inserting opening 11 by the second Z axis distance. Therefore, the cam pins 35A and 35B move toward the one ends of the grooves of the fixing cams 34A and 34B by the second X axis distance, but the height of the other end (close to the pickup 32) of the traverse mechanism 30 is not varied. The vertically moving pin 54 moves in the groove of the vertically moving cam mechanism 52 by the fourth Y axis direction to move the one end (close to the spindle motor 31A) of the traverse mechanism 30 toward the base body 10, and disposes the one end at a location of the first Z axis distance.

Through the above-described motion, the disk is separated from the lid 130 and also from the fixing pin 120, and the disk is brought into a replay/recording state.

When the loaded disk is to be discharged, the loading motor is driven, the main slider 40 is moved toward its other end, and basically the above-described motion is carried out reversely.

### INDUSTRIAL APPLICABILITY

The disk apparatus of the embodiment is especially effective as a disk apparatus which is incorporated or integrally provided in a so-called notebook personal computer in which display means, input means, processing means and the like are integrally provided.

1. A chucking method of a disk apparatus comprising a chassis outer sheath having a base body and a lid, in which
a front surface of said chassis outer sheath is formed with a disk inserting opening into which a disk is directly inserted, a traverse mechanism provided on said base body comprises a spindle chassis and a traverse base, said spindle chassis holds a plurality of columns which support a spindle motor and said traverse base, said traverse base holds a pickup and drive means which moves said pickup, said traverse base is fitted to said columns of said spindle chassis, said traverse base is disposed and fixed to said spindle chassis in a state where said traverse base is biased by a spring mounted on said columns of said spindle chassis so that said traverse base can approach and separate from said spindle chassis such that a center of said spindle motor of said spindle chassis and a center line of a pickup lens when said pickup of said traverse base moves match with each other,
a slider mechanism is disposed on one end side of said traverse mechanism,
said slider mechanism includes a cam mechanism which brings one end side of said traverse mechanism close to and away from said base body, and a slider cam mechanism which moves said traverse mechanism in an inserting/discharging direction of said disk, a fixing cam is disposed on the other end side of said traverse mechanism, the other end of said traverse mechanism is supported on said base body by said fixing cam,
said traverse mechanism is moved by said slider cam mechanism, thereby bringing the other end side of said traverse mechanism close to and away from said base body by said fixing cam,
when said traverse mechanism moves toward said base body, said spindle chassis and said traverse base are biased by the springs mounted on the columns of said spindle chassis, thereby moving integrally said spindle chassis and said traverse base toward said base body until said traverse base abuts against said base body, and only said spindle chassis moves toward said base body if the traverse base abuts against said base body,
and when said traverse mechanism moves away from said base body, only said spindle chassis moves away from said base body while said traverse base is in abutment against said base body, and when said traverse mechanism further moves away from said base body, said spindle chassis and said traverse base move integrally away from said base body, wherein
said chucking method comprises
a first step for moving said traverse mechanism toward said fixing cam, thereby moving only the other end side of said spindle chassis away from said base body,
a second step for moving only said spindle chassis away from said base body until said traverse base moves away from said base body after the first step, and for moving integrally said spindle chassis and said traverse base away from said base body when said traverse base further moves away from said base body, thereby fitting said disk to a hub of said spindle motor, and
a third step for moving the one end side of said traverse mechanism toward said base body after the second step.

2. The chucking method of the disk apparatus according to claim 1, wherein said traverse mechanism is moved toward said fixing cam after the second step, thereby moving said disk away from a position limiting member.

3. A chucking method of a disk apparatus in which a traverse mechanism comprises a spindle chassis and a traverse base, said spindle chassis holds a plurality of columns which support a spindle motor and said traverse base, said traverse base holds a pickup and drive means which moves said pickup, said traverse base is fitted to said columns of said spindle chassis, said traverse base is disposed and fixed to said spindle chassis in a state where said traverse base is biased by a spring mounted on said columns of said spindle chassis so that said traverse base can approach and separate from said spindle chassis such that a center of said spindle motor of said spindle chassis and a center line of a pickup lens when said pickup of said traverse base moves match with each other,
the one end side or the other end side of said traverse mechanism is moved perpendicularly to said base body, and said traverse mechanism is moved horizontally with respect to said base body,
when said traverse mechanism moves toward said base body, said spindle chassis and said traverse base are biased by the springs mounted on said columns of said spindle chassis , thereby moving integrally said spindle chassis and said traverse base toward said base body until said traverse base abuts against said base body, only said spindle chassis moves toward said base body, if said traverse base abuts against said base body,
and when said traverse mechanism moves away from the base body, only the spindle chassis moves away from the base body while the traverse base is in abutment against the base body, and when said traverse mechanism further moves away from the base body, said spindle chassis and said traverse base move integrally away from said base body, wherein
said chucking method comprises
a first step for moving said traverse mechanism in the horizontal direction, thereby moving only the other end side of said spindle chassis away from said base body,
a second step for moving only said spindle chassis away from said base body until said traverse base moves away from said base body after the first step, and for moving integrally said spindle chassis and said traverse base away from said base body when said traverse base further moves away from said base body, thereby fitting said disk to a hub of said spindle motor, and
a third step for moving the one end side of said traverse mechanism toward said base body after the second step.

4. The chucking method of the disk apparatus according to claim 3, wherein said traverse mechanism is moved in the horizontal direction after the second step, thereby moving said disk away from a position limiting member.

5. A disk apparatus comprising a chassis outer sheath having a base body and a lid, in which
a front surface of said chassis outer sheath is formed with a disk inserting opening into which a disk is directly inserted, a traverse mechanism provided on said base body comprises a spindle chassis and a traverse base, said spindle chassis holds a plurality of columns which support a spindle motor and said traverse base, said traverse base holds a pickup and drive means which moves said pickup, said traverse base is fitted to said columns of said spindle chassis, said traverse base is disposed and fixed to said spindle chassis in a state where said traverse base is biased by a spring mounted on said columns of said spindle chassis so that said traverse base can approach and separate from said spindle chassis such that a center of said spindle motor of said spindle chassis and a center line of a pickup lens when said pickup of said traverse base moves match with each other, wherein
a slider mechanism is disposed on one end side of said traverse mechanism,
said slider mechanism includes a cam mechanism which brings one end side of said traverse mechanism close to and away from said base body, and a slider cam mechanism which moves said traverse mechanism in an inserting/discharging direction of said disk, a fixing cam is disposed on the other end side of said traverse mechanism, the other end side of said traverse mechanism is supported on said base body by said fixing cam,
said traverse mechanism is moved by said slider cam mechanism, thereby bringing the other end side of said traverse mechanism close to and away from said base body by said fixing cam,
when said traverse mechanism moves toward said base body, said spindle chassis and said traverse base are biased by the springs mounted on the columns of said spindle chassis, thereby moving integrally said spindle chassis and said traverse base toward said base body until said traverse base abuts against said base body, and only said spindle chassis moves toward said base body if the traverse base abuts against said base body,
and when said traverse mechanism moves away from said base body, only said spindle chassis moves away from said base body while said traverse base is in abutment against said base body, and when said spindle chassis further moves away from said base body, said spindle chassis and said traverse base move integrally away from said base body.

6. The chucking method of the disk apparatus according to claim 5, wherein said traverse mechanism is moved toward a fixing cam by said slider cam mechanism, thereby moving said disk away from a position limiting member.
